(19) United States
(12) Patent Application Publication
(10) Pub. No.: US 2003/0135758 A1
(43) Pub. Date: Jul. 17, 2003

(54) System and method for detecting network events

(76) Inventor: Elliot B. Turner, Richardson, TX (US)

Correspondence Address: Brobeck Phleger & Harrison, LLP, 12390 El Camino Real, San Diego, CA, 92130, US

(21) Appl. No.: 10/199,893

(22) Filed: Jul. 19, 2002

Related U.S. Application Data
(60) Provisional application No. 60/306,588, filed on Jul. 19, 2001.

(51) Int. Cl. H04L 9/00

(52) U.S. Cl. 713/201

(57) ABSTRACT

A method of determining a network event includes copying data communicated across a network and determining the network event using a stub function generated by an end-user.

### PRIORITY CLAIM TO RELATED PROVISIONAL APPLICATION

The present application claims a right of priority under 35 U.S.C. §119 to U.S. provisional patent application entitled “SYSTEM AND METHOD FOR DETECTING NETWORK EVENTS” having Serial No. 60/306,588, filed Jul. 19, 2001.

### BACKGROUND OF THE INVENTION

As businesses and government agencies become more dependent on sophisticated computer networks to operate internally and conduct business with third parties, network security is becoming both more necessary and more difficult.

More information flowing across today's computer networks necessitates the analysis of greater quantities of data for detecting potential network events. However, current security systems are unable to respond quickly enough to new forms of attack that are created in greater numbers and evolve with greater speed than ever before. One barrier to network hosts quickly assessing and detecting new security risks is that such security systems require updates from the manufacturer before they can be reconfigured to detect new potential threats, creating windows of network vulnerability to such threats while new updates are obtained. While vendors may distribute source code to security systems in order to allow end-users to modify or customize such systems, such a distribution requires that the end-user have a suitably skilled programmer versed in protocol decoding and capable of modifying the source code. Such distribution also exposes such source code to potential access by hackers.

### TECHNICAL FIELD OF THE INVENTION

This invention relates in general to the field of network security, and more particularly to a system and method for detecting network events.

### SUMMARY OF THE INVENTION

In accordance with the present invention, a system and method for detecting network events is disclosed that has substantial advantages over previous systems and methods of detecting network events.

In one embodiment of the present invention, a method of detecting network events is disclosed. The method includes copying data communicated across a network and determining the network event using a stub function generated by an end-user. Various other embodiments of the present invention are disclosed.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is one embodiment of a system for detecting network events implemented according to the teachings of the present invention;

FIG. 2 is one embodiment of a computer used to implement various components of the system illustrated in FIG. 1 implemented according to the teachings of the present invention;

FIG. 3 is one embodiment of a parsal tree using shared decision logic and representing regular expressions implemented according to the teachings of the present invention;

FIG. 4 is one embodiment of a process for detecting network events using a stub function and implemented according to the teachings of the present invention;

FIG. 5 is one embodiment of a process for determining the presence of a data string according to the teachings of the present invention; and

FIG. 6 is one embodiment of a process for compiling scripts into bytecode according to the teachings of the present invention.

### DETAILED DESCRIPTION OF THE INVENTION

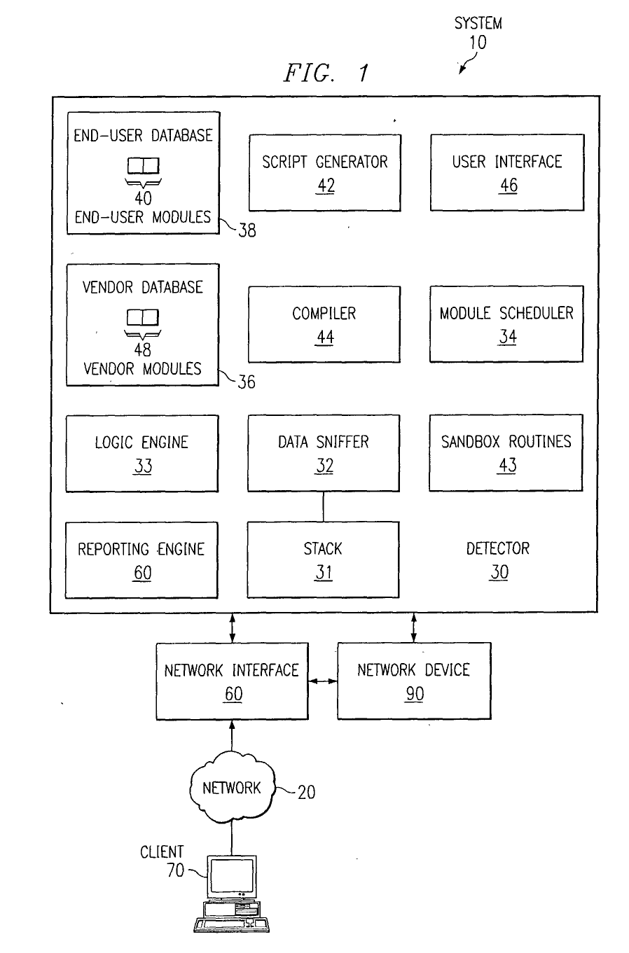

FIG. 1 illustrates one embodiment of a system 10. In general, the system 10 is a data analysis system that uses combinational decision logic to detect network events by analyzing single packets or sessions of packets. In particular, the system 10 uses decoding modules that include scripts identifying functions, decision logic, and/or regular expressions of data that are all used to detect particular network events. For purposes of this invention, a regular expression is a defined class of strings defined by specifying a data type, format style, size/length, particular characters or values of data, and/or any other suitable characteristics of data.

The decoding modules also utilize shared decision logic to enable simultaneous analysis and detection of many different network events. Functions, decision logic, and regular expressions may be defined and customized by a end-user after a product incorporating the invention has been shipped by a manufacturer, and can be continually modified and replaced in response to threats to network security. Additionally, in one embodiment, the detection of security risks and other network events using end-user defined functions and decision logic is accomplished in a sandbox environment, protecting the resources of system 10 from miscoding and other errors an end-user may make in customization.

In the illustrated embodiment, system 10 includes a detector 30 in communication with a network device 90, and both being further in communication with a network 20 over a network interface 60. The detector 30 is further in communication with a client 70 over the network 20.

In the illustrated embodiment, the network 20 is the Internet; however, alternatively, the network 20 may be one or more wired or wireless networks, whether public or private, having dedicated or switched links. For example, components of the system 10 may communicate with each other over a local area network, a wide area network, or a virtual private network. The network 20 may be implemented using fiber, cable, twisted-pair, satellite, radio, microwave, laser, or other suitable wired or wireless links.

In the illustrated embodiment, the network interface 60 is an Ethernet network interface card; alternatively, however, the network interface 60 may be any other suitable wired or wireless interface, modem, or gateway. Thus, the network interface 60 may be any suitable network communications hardware and/or software to enable communication between network device 90 and other network components. The network interface 60 and the detector 30 may also be integrated together within the network device 90 or within a network gateway or other network node.

In the illustrated embodiment, the network device 90 is a server accessible via network 20. Alternatively, the network device 90 may be any network device either forming a part of a network infrastructure or accessible thereby. For example, the network device 90 may be: a router, switch, bridge, or hub; a personal computer accessible via network 20; a network appliance or other application specific device; or a personal digital assistant, messaging device, or other wireless end-user device.

In the illustrated embodiment, the client 70 is a personal computer; alternatively, however, the client 70 may be a client, workstation, terminal, personal computer, web appliance, personal digital assistant, cellular telephone, pager or any other suitable computing device having input and output modules that enable a user to enter and view data. The client 70 may include a web browser or other interface software and/or hardware, volatile or non-volatile memory, processor and/or other processing components, and/or other software, hardware, and peripherals suitable for such a computing device.

As discussed, the client 70 may maintain and execute browsers or other suitable parsing programs for accessing and communicating information addressed by Uniform Resource Locators (URLs). Any suitable communications protocol may be implemented in combination with one or more generally available security and/or encryption techniques to ensure the secure, private communication of data between the detector 30 and the client 70.

In the illustrated embodiment, the detector 30 includes a stack 31, a data sniffer 32, a logic engine 33, a module scheduler 34, a vendor database 36, an end-user database 38, a script generator 42, one or more sandbox routines 43, a compiler 44, a user interface 46, and a reporting engine 50.

In the illustrated embodiment, the stack 31 is a TCP/IP stack; however, alternatively, the stack 31 may be any other suitable protocol stack depending on the protocol of data to be decoded by the detector 30.

In the illustrated embodiment, the data sniffer 32 is libpcap, a commercially available software library for capturing packets of data communicated across a network. Alternatively, the data sniffer 32 may be Turbopacket, another commercially available software program available as a patch to the Linux (TM) operating system kernel, or any other suitable combination of software and/or hardware that copies data traveling over the network 20 through the network interface 60 for monitoring and analysis by the remainder of the detector 30. In the illustrated embodiment, the data sniffer 32 is a packet sniffer operable to copy packets communicated via any raw Ethernet frame including higher-level protocols such as, for example, Transfer Control Protocol, Internet Protocol, User Datagram Protocol, or Internet Control Message Protocol. However, the data sniffer 32 may additionally be configured to copy data communicated on networks using other protocols for communicating data including non-packet-based protocols.

In the illustrated embodiment, the logic engine 33 includes packet validation software and session reconstruction software. The packet validation software validates packets copied by the data sniffer 32 from stack 31 to verify that the packets contain valid network information. The session reconstruction software assembles information from various packets in order to reconstruct the session of a particular user or access attempt from a particular IP address or other network node.

In the illustrated embodiment, the module scheduler 34 is a software application configurable by a user to select particular decoder modules from the vendor database 36 and the end-user database 38 to be used to analyze data copied by the packet sniffer 32.

The vendor database 36 includes vendor modules 48, each of which is a vendor defined decoding module that includes functions, shared decision logic, regular expressions, and/or other components configured by a vendor to be used in protocol decoding and network event detection. For example, a particular vendor module 48 may be a module devoted to decoding a particular protocol such as HTTP. Such vendor module 48 may therefore fully decode network data communicated using HTTP and interpret such network data in order to detect events predetermined by the vendor. In particular, a particular vendor module 48 may keep state information during one or more network sessions, identify login attempts, passwords utilized, monitor for command sequences, classify sessions by type, and identify other various forms of data such as Uniform Resource Locators, chat channels, nicknames, email addresses, message subjects, remote login sessions, and files accessed, printed, or transferred.

One or more of the vendor modules 48 may also include calls to functions that are not defined by the vendor. Such functions are referred to throughout this application as stub functions. Such a stub function shall have a reserved function name that can be defined and scripted by an end-user using the script generator 42. The use of stub functions in the system 10 allows an end-user to utilize the full protocol decoding aspects of a particular vendor module 48 to perform customized functions without having to fully understand how such full protocol decoding may be implemented. By allowing an end-user to compose scripts for function calls included within a particular vendor module 48, the end-user may benefit from the decoding logic implemented by the manufacturer and are prevented from having to write scripts to perform protocol decoding themselves.

The end-user database 38 includes the end-user modules 40, each of which is an end-user defined coding module that includes functions, shared decision logic, regular expressions, and/or other components configured by an end-user in a script to be used in protocol decoding and network event detection. Alternatively, a particular end-user module 40 may be a stub function defined by an end-user script and executed by loading a particular vendor module 48 that includes a function call to that particular end-user module 40.

Both the vendor modules 48 and the end-user modules 40 include decision tree structures generally referred to as parsal trees. Such parsal trees are either precompiled by a vendor from vendor generated decoding scripts or compiled by the compiler 44 from end-user generated scripts using the script generator 42. In particular, such parsal trees may include byte code version of several functions, sequenced or looped executions of decision logic, and/or variants of regular expressions of data used by the decoding modules 40 and 48 to identify network events such as security risks. Each parsal tree may use shared decision logic to support simultaneous detection of multiple data strings within network data. For example, a parsal tree may include decision paths used to monitor for the characters l, o, g, i and n in sequence in order to detect a login command, and simultaneously include decision paths used to monitor data sent using Simple Mail Transfer Protocol. A representation of a particular parsal tree is illustrated in FIG. 3.

Regular expressions included within parsal trees define a class of strings searchable by a particular decoding module 40 or 48 when analyzing data captured using the data sniffer 32. For example, a regular expression may define a login attempt by a particular user identification pattern. In such an example, characters representing a login attempt can be combined with a class of a user name defined by length or any other suitable criteria. The regular expression can then be implemented within one or more of the decoding modules 40 and/or 48 for comparison to network data.

Both the vendor modules 48 and the end-user modules 40 may be used to monitor individual packets of data or one or more network sessions including thousands of packets of data. When analyzing network sessions, both types of the decoding modules 40 and 48 may utilize state-based detection wherein current packets of data communicated during a particular network session are analyzed in part based on data detected in earlier packets communicated during the particular network session or an earlier network session.

In the illustrated embodiment, the detector 30 is configured so as to independently execute each function utilized in a particular decoding module 40 or 48 in a sandbox environment. More particularly, each function is executed in a manner such that the remainder of the detector 30, or a host computer including the detector 30, is protected from being overwritten or over-utilized. Such protection is particularly important when executing end-user defined functions that may include looped execution. Such a sandbox environment allows end-users of the detector 30 to make custom enhancements and create particular scripts without the risk that a particular poorly-made enhancement or poorly-written script will crash or harm the detector 30, a host computer, or other network components.

The detector 30 includes one or more sandbox routines 43 to enable such a sandbox environment. For example, the detector 30 includes extensive run-time analysis of all executed code to detect runaway or infinite loops. The detector 30 may also include memory allocation limits specific to a piece of executed code to prevent over-utilization of system resources. The detector 30 may further include function recursion limits, preventing nested function calls from becoming an endless loop. Additionally, the detector 30 may include full run-time memory checking, to prevent invalid accesses or allocation of variables, arrays, and pointers within invalid, unallocated, or protected address spaces. Further, the detector 30 may include a facility for safe pointer allocation. More particularly, the full memory protection of the detector 30, together with tracking of resources used by an executed piece of code, allows an end-user to safely use pointers without causing invalid memory utilization conditions and pointer memory de-allocation.

In the illustrated embodiment, the script generator 42 is a text-based editor operable to allow an end-user to compose functions, shared decision logic, looped executions, and/or regular expressions for execution as one of the end-user modules 40. For example, a system administrator for a network can use the script generator 42 to detect a particular form of attack, monitor behavior of a particular network user, or otherwise customize the detection capabilities of the detector 30. Users of the script generator 42 may use a particular grammar definition language similar to C or other suitable language or syntax. In general, in defining a particular end-user module 40, users of the script generator 42 can compose regular expression definitions, declare constants, variables, and functions, utilize variable type-casting, use variable type checking on function calls, perform mathematical operations, utilize dynamically resizable pointers, utilize recursive function calls, and utilize comparisons, loop statements, and Boolean logic.

In one embodiment, the script generator 42 is a menu-driven expression builder written using an X Windows application and allowing a user to select a particular function or characteristics of a regular expression and prompting the user to enter text or other data strings where appropriate. In such an embodiment, the script generator 42 may alternatively be a web-based Java application maintained by the user interface 46 or any other suitable program interface.

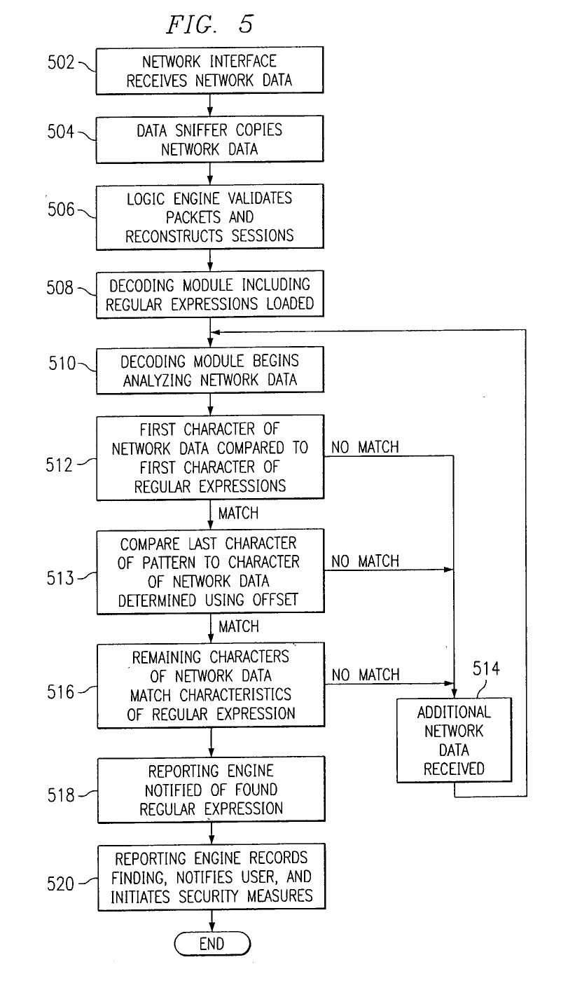

In the illustrated embodiment, the compiler 44 includes a byte code generator that converts end-user composed scripts into bytecode. In one embodiment, the compiler 44 includes an interpreter programmed to convert byte code into cached machine language instructions. The operation of the compiler 44 is further described in reference to FIG. 5. The compiler 44 may also include a JIT (just-in-time) compiler. The JIT compiler converts end-user modules 40 and vendor modules 48 from bytecode into machine language instructions for a processor. The JIT compiler then stores the machine language instructions in a cache for execution. No permanent copy of the machine language instructions is separately maintained. Alternatively, the compiler 44 may include a Java interpreter or other suitable compiler operable to convert byte code versions of the decoding modules 40 and 48 into cached machine language instructions.

The module scheduler 34 is a program interface configurable by an end-user to select particular vendor modules 48 or end-user modules 40 for execution by the detector 30 to monitor network data communicated through the network interface 60. In such a manner, an end-user such as a system administrator may include or exclude particular end-user modules 40 in response to recent forms of network attacks or vulnerabilities.

In the illustrated embodiment, the reporting engine 50 is a storage and notification engine used to record instances in which a particular vendor module 48 or end-user module 40 has detected a network event. The reporting engine 50 includes a database for recording data associated with the detected event, such as time, source address, destination address, any associated user identification, and any other network data associated with the detected string. The reporting engine 50 also includes notification algorithms including routines to notify system administrators, network security officers, or other users or administrative personnel via email, voicemail, paging, network broadcast, or any other suitable notification channels. The reporting engine 50 may also be configured to initiate any suitable automated network security measures, such as one to cause the network interface 60 or the network device 90 to restrict access to the network device 90 altogether, by a particular user, or block data communicated from a particular source address.

In the illustrated embodiment, the user interface 46 is a web-based user interface included within the detector 30. Alternatively, the user interface 46 may be deployed on a separate web server in communication with the detector 30 via a private network or the network 20. The user interface 46 stores web pages, JAVA servlets, and other suitable content and executables to enable users of the system 10 to easily access the features and capabilities of the detector 30 using the client 70.

In the illustrated embodiment, various components of the system 10 are implemented in a programming environment that supports access or linking to various sources of information using URL addresses. As such, the content of such modules and databases may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. The modules of the system 10 may also include program code, such as applets or servlets written in Java, or other appropriate self-executing code.

Although various components of the detector 30 are illustrated in this FIG. 1 as separate components, the components of the detector 30 may be implemented using a single processor such that the single processor accesses stored algorithms, executables, and other data that are stored in read-only memory, for example, and executed using random access memory. Likewise, any databases, modules, subsystems and other illustrated may be combined, separated or distributed across one or more processing and/or memory devices. Memory for such databases, modules, subsystems, or other components of the detector 30 may be implemented using one or more files, data structures, lists, or other arrangements of information stored in one or more components of random access memory, read-only memory, magnetic computer disks, compact disks, other magnetic or optical storage media, or any other volatile or non-volatile memory.

Likewise, it should be understood that any components of the system 10 may be internal or external to the illustrated components of the system 10, depending on the particular implementation. Also, databases, modules, subsystems or other components of the detector 30 may be separate or integral to other components. Any appropriate referencing, indexing, or addressing information can be used to relate back to an address or location of a database, file or object within the system 10.

The operation of the system 10 is described in the following portions of the description referring to FIGS. 3 through 6. However, in general, the detector 30 monitors data communicated through the network interface 60 to the network device 90. In particular, the data sniffer 32 copies packets or other subsets of data communicated through the network interface 60. The detector 30 then uses the decoding modules 40 and/or 48 to analyze the copied data using a combination of functions, decision logic, and pattern matching of network data to regular expressions. End-user modules 40 are generated as scripts by an end-user, such as a network administrator, and are then compiled to form a bytecode version of a parsal tree to be used in analyzing network data. Upon detecting a particular network event, the detector 30 communicates the detected network event and associated information to the reporting engine 50 for archive, notification of personnel, and/or implementation of automated security measures.

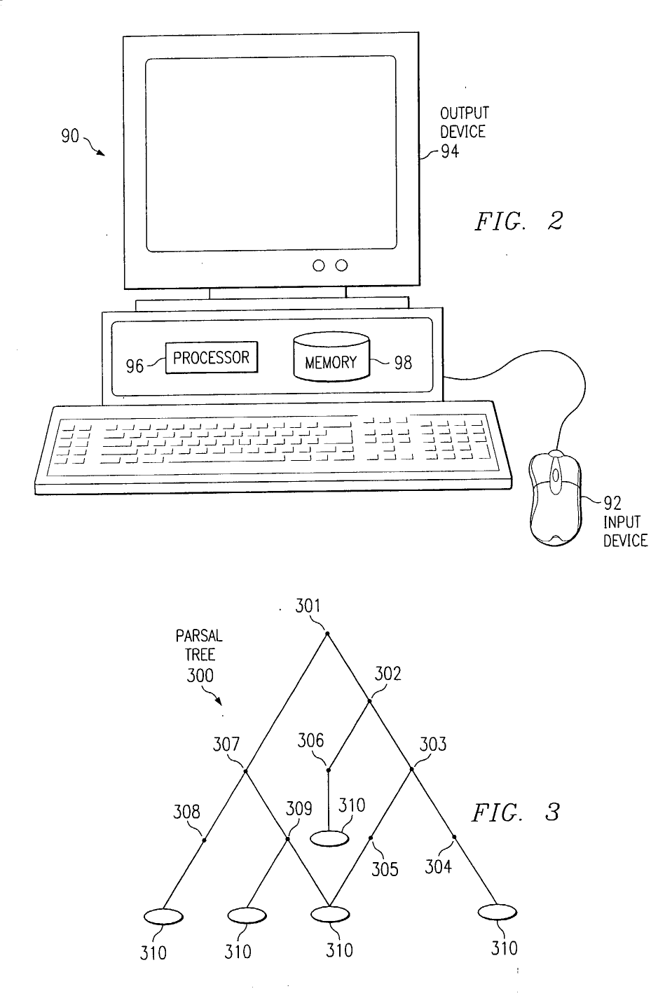

Referring to FIG. 2, in one embodiment, the detector 30 and/or the client 70 operate on one or more computers 90. Each computer 90 includes one or more input devices 92 such as a keypad, touch screen, mouse, microphone, or other suitable pointer or device that can accept information. An output device 94, such as a speaker, monitor or other display, for example, conveys information associated with the operation of the detector 30 or the client 70, including digital data, visual information, and/or audio information. A processor 96 and its associated memory 98 execute instructions and manipulate information in accordance with the operation of the system 10. For example, the processor 96 may execute coded instructions that are stored in the memory 98. The computer 90 may also include fixed or movable storage media such as a magnetic computer disk, CD-ROM, or other suitable media to either receive output from, or provide output to the detector 30 or the client 70.

Now referring to FIG. 3, one embodiment of a representation of a particular parsal tree 300 used by system 10 is illustrated. In particular, the parsal tree 300 is used to analyze a subset of network data such as one or more packets of data. At node 301 of the parsal tree 300, a particular character or data value (hereafter referred to as character) is indicated to be compared the network data. At nodes 302 and 306, provided the character indicated at node 301 has been found within the network data, the detector 30 would examine the next consecutive character of the network data for the presence of the characters or values indicated at nodes 302 or 306. In one embodiment, in nodes 302 and 306, the detector 30 would examine a character of the network determined by an offset value associated with a particular string of data being detected. For example, a string having five characters may search for the fifth character in network data after the first one is detected using an offset of four to identify the correct character of network data. If detected, the remaining three characters would be searched for. In such a manner, using the parsal tree 300 and the shared decision logic included therein, the parsal tree 300 can simultaneously test for the presence of multiple strings of data using the same decision tree and therefore using a single executable routine rather than several consecutive routines.

The presence of the character indicated at node 302 leads to decision paths used by the detector 30 to test for consecutive additional characters or values indicated at node 303, followed by nodes 304 and 305, and at node 306. The presence of the character indicated at node 307 leads to decision paths used by the detector 30 to test for consecutive additional characters or values indicated at nodes 308 and 309. In any event, a detected string of data may trigger a detected network event 310, each network event 310 being associated with follow-up procedures such as logging data in a database within the reporting engine 50, initiating notification procedures, or implementing automated security procedures through the reporting engine 50. In one embodiment, a detected string of data causes the following procedure of system 10 to test for the presence of a particular string of data in that same or another subset of network data. Thus, one or more parsal trees 300 may be used to detect network events involving the use of multiple strings of data communicated across a network such as network 20. The parsal tree 300 may include other functionality not represented in this FIG. 3. For example, parsal tree 300 may include sequenced or looped executions, particular functions to be performed on data, and/or other decision logic.

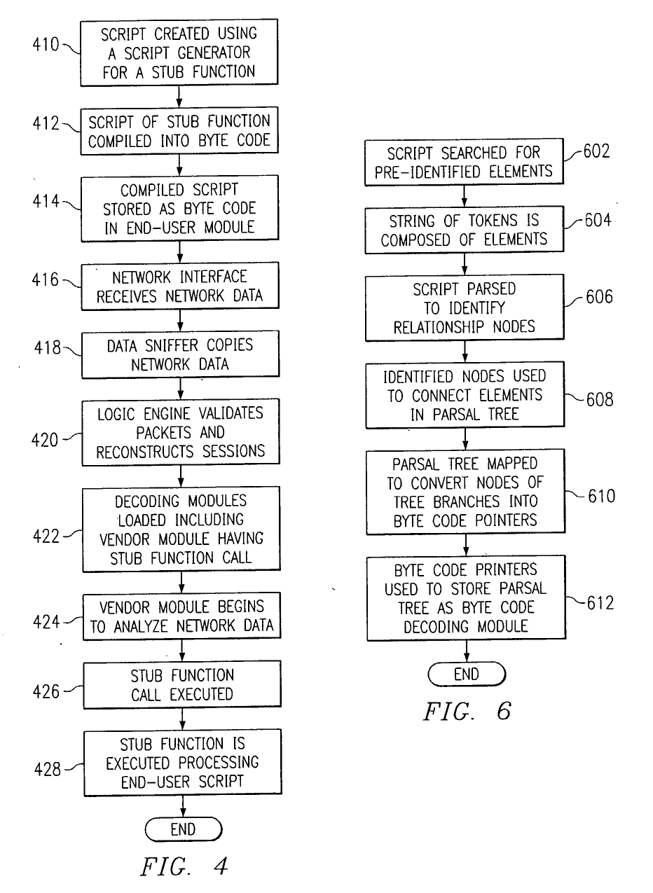

Now referring to FIG. 4, one embodiment of a process for detecting networks events using the components of system 10 and a stub function is illustrated. In step 410, a script is created by a user of the script generator 42 for a stub function corresponding to a stub function call included within a particular vendor module 48. In step 412, the stub function is generated by compiler 44 as further described in FIG. 6 in order to generate a parsal tree representation of the script in bytecode format. In step 414, the stub function is stored as a particular end-user module 40.

In step 416, the network interface 60 receives a network packet or other set of network data. In step 418, the data sniffer 32 copies the received network data. In step 420, the logic engine 33 validates packets of network data, discards invalid packets, and reconstructs session data from validated packets of network data. In step 422, the detector 30 loads one or more vendor modules 48 selected by the end-user using the module scheduler 34, including the particular vendor module 48 having the stub function call corresponding to the stub function created by the end-user.

In step 424, the detector 30 executes the particular vendor module 48 and begins to analyze validated and reconstructed network data copied by the data sniffer 32. In step 426, the particular vendor module 48 executes the stub function call and passes the stub function decoded network data. In step 428, the stub function is executed processing the script defined by the end-user in step 410.

Now referring to FIG. 5, a process for determining the presence of a string of data is illustrated. Such a string of data may be included in parsal tree found in one of the end-user modules 40 or the vendor modules 48. In step 502, the network interface 60 receives a network packet or other set of network data. In step 504, the data sniffer 32 copies the received network data. In step 506, the logic engine 33 validates packets of network data, discards invalid packets, and reconstructs session data from validated packets of network data. In step 508, the detector 30 loads one or more decoding modules 40 and/or 48 selected by the end-user using the module scheduler 34, including a decoding module 40 or 48 having at least one parsal tree including strings of data defining desired network data to be detected.

In step 510, the detector 30 executes the decoding module 40 or 48 and begins to analyze validated and reconstructed network data copied by the data sniffer 32 in order to determine the presence of any data meeting the characteristics of the regular expressions included with the parsal tree. In step 512, the decoding module 40 or 48 determines if the first character of the received network data matches the first character of any regular expression included within the parsal tree. If no first characters match, the decoding module 40 or 48 receives additional network data in step 514 and repeats the process.

If the first characters do match, the decoding module 40 or 48 determines if the last character of indicated potential regular expressions matches what would be the corresponding character of the network data. To determine the appropriate corresponding last character, the decoding module 40 or 48 determines an offset value based on the number of characters separating the first and last characters of the regular expression. Using such offset value, the appropriate character of network data may then be compared to the last character of the regular expression to determine a match. By using such an offset value in combination with the identity of the last character of the regular expression, a significant decrease in the number of comparisons necessary is achieved. Rather than just comparing characters sequentially, combining a last character comparison with an offset value allows a two-dimensional comparison that quickly eliminates regular expressions that are not present.

If the last characters do not match, the decoding module 40 or 48 receives additional network data in step 514 and repeats the process. If the last characters do match, the decoding module 40 or 48 determines if the remaining characters of the received network data match the characteristics of the regular expressions included in the parsal tree in step 516.

If none of the regular expression(s) are found, the decoding module 40 or 48 receives additional network data in step 514 and repeats the process. If one of the regular expression(s) is found in step 516, the detected network data matching the regular expression(s) and associated information regarding the network data is communicated to the reporting engine 50 in step 518. Alternatively, system 10 may then attempt to detect the presence of one or more additional strings of data to determine the presence of a network event associated with multiple strings of data. In step 520, the reporting engine 50 records the information, performs any configured notification procedures, and initiates any automated network security measures associated with the detected network data.

Now referring to FIG. 6, the process of generating end-user generated scripts using the compiler 44 is illustrated. In step 602, the compiler 44 uses a string search command such as a grep command to search for pre-identified elements in a particular script such as characters or strings of data, constants, operators, loops, commands, regular expressions and/or functions. In step 604, such pre-identified elements are used to compose a string of tokens wherein each token represents an element. In step 606, the script is parsed to identify tokens as nodes that represent relationships between other tokens and therefore define logical relationships. In step 608, each such node token representing such a relationship is used to connect other related elements of the script in order to generate a parsal tree. Relationships may be nested and interdependent, creating a parsal tree with many levels of branches. In general, the parsal tree is composed from the bottom up first identifying relationships between individual elements and then groups of elements in a hierarchical framework. In step 610, the resulting parsal tree is mapped by a routine that walks the tree in order to convert relationships previously defined by nodes of tree branches into pointers showing relationships between elements. In step 612, the resulting pointers are stored as a byte code representation of the parsal tree for storage as a particular end-user module 40, for example. Thus using, the process illustrated by this FIG. 6, a script including the mathematical operation (2+3)*4 can be parsed into a series of tokens ‘(’, ‘2’, ‘+’, ‘3’, ‘*’ and ‘4’ in step 604. In step 606, ‘+’ and ‘*’ are identified as nodes showing relationships between ‘2’, ‘3’, and ‘4’. In step 608, a parsal tree is generated to result in the following representation:

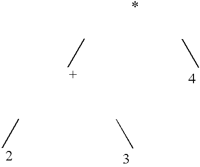

In step 610, the parsal tree illustrated above is represented using pointers to identify branched relationships of the parsal tree and stored in bytecode format in step 612.

Although particular embodiments of the present invention have been explained in detail, it should be understood that various changes, substitutions, and alterations can be made to such embodiments without departing from the spirit and scope of the present invention as defined solely by the following claims.

What is claimed is:

1. A method of determining a network event, the method comprising:
copying data communicated across a network; and
determining the network event using a stub function generated by an end-user.

2. The method of claim 1, wherein determining the network event includes comparing the data to each of a plurality of regular expressions, at least one of the plurality of regular expressions being included in the stub function.

3. The method of claim 1, wherein determining the network event includes comparing the data to a parsal tree, the parsal tree including paths operable to define each of a plurality of regular expressions.

4. The method of claim 1, and further comprising executing a command to load the stub function at run-time.

5. The method of claim 1, wherein determining the network event includes analyzing the data using a compiled script to execute instructions, the instructions operable to be modified by the end-user using a function call included within the compiled script.

6. The method of claim 5, and further comprising adding regular expressions to the instructions using the function call.

7. The method of claim 1, wherein determining the network event further comprises calling a plurality of functions wherein at least one of the plurality of functions is executed in a sandbox environment relative to at least one other of the plurality of functions.

8. A detector for determining a network event, the detector comprising:
a data sniffer operable to copy data communicated across a network; and
a decoding module in communication with the data sniffer and operable to determine a network event by analyzing the copied data, the decoding module analyzing the data using a stub function generated by an end-user.

9. The detector of claim 8, and further comprising a script generator in communication with the decoding module and operable to generate scripts to analyze the copied data.

10. The detector of claim 8, and further comprising a module scheduler in communication with the decoding module and operable to select the decoding module to analyze the copied data.

11. The detector of claim 8, and further comprising a logic engine in communication with the data sniffer and operable to validate packets of the copied data and reconstruct sessions of the copied data.

12. The detector of claim 8, and further comprising a compiler in communication with the decoding module and operable to generate the decoding module using bytecode converted from a script written by the end-user.

13. The detector of claim 8, and further comprising one or more sandbox routines in communication with the decoding module and operable to protect the detector during run-time from one or more errors in the generated stub function.

14. The detector of claim 8, wherein the decoding module includes state information operable to be updated during one or more network sessions, the state information being further operable to enable state-based detection of the network event.

15. The detector of claim 8, wherein the decoding module is a vendor module operable to enable full protocol decoding.

16. The detector of claim 8, wherein the decoding module includes at least one parsal tree, the decoding module operable to detect the network event using shared decision logic included in the parsal tree.

17. A method of determining a network event using a stub function, the method comprising:
receiving data communicated over a network;
loading a decoding module, the decoding module including a stub function call;
performing the stub function call; and
determining the network event in response to performing the stub function call.

18. The method of claim 17, and further comprising:
receiving a script corresponding to the stub function call; and
generating a parsal tree in response to receiving the script.

19. The method of claim 18, wherein generating the parsal tree further comprises:
searching the script to identify predetermined elements;
composing a string of tokens corresponding to the identified predetermined elements;
parsing the script to identify nodes representing relationships between one or more of the string of tokens; and
generating the parsal tree in response to the identified nodes and the composed string of tokens.

20. The method of claim 19, and further comprising converting the parsal tree into one or more pointers representing relationships between the identified predetermined elements.

21. The method of claim 20, and further comprising storing the one or more pointers as byte code in an end-user module operable to be called by the stub function call.

22. The method of claim 19, wherein the parsal tree is generated in response to identifying relationships between individual elements of the identified predetermined elements and between groups of the identified predetermined elements.

23. The method of claim 18, wherein the parsal tree is generated in a hierarchical fashion.

24. A computer usable medium having computer readable program code embodied in the computer usable medium, the computer readable program code executable by a computer to perform a method of determining a network event, the method comprising:
loading a decoding module, the decoding module including a stub function call;
performing the stub function call; and
determining the network event in response to performing the stub function call.

25. The computer usable medium of claim 24, wherein performing the stub function call includes executing a script of instructions operable to identify one or more network events defined by an end-user.

26. The computer usable medium of claim 24, wherein performing the stub function call includes executing a script of instructions operable to compare network data to regular expressions.

27. The computer usable medium of claim 24, wherein performing the stub function call includes executing a script of instructions operable to perform functions on network data.

28. The computer usable medium of claim 24, wherein performing the stub function call includes executing a script of instructions operable to use variable type checking of network data.

29. The computer usable medium of claim 24, wherein performing the stub function call includes executing a script of instructions operable to use dynamically resizable pointers for analyzing network data.

30. The computer usable medium of claim 24, wherein performing the stub function call includes executing a script of instructions operable to use recursive function calls for analyzing network data.
